(19) United States
(12) Patent Application Publication
(10) Pub. No.: US 2026/0100385 A1
(43) Pub. Date: Apr. 9, 2026

(54) CRASH-WORTHY AND BALLISTICALLY TOLERANT FUEL CELL FABRICATING METHOD

(71) Applicant: Response Technologies LLC, Coventry, RI (US)

(72) Inventor: David Allen Pettey, Portsmouth, RI (US)

(73) Assignee: Response Technologies LLC, Coventry, RI (US)

(21) Appl. No.: 18/898,743

(22) Filed: Sep. 27, 2024

(51) Int. Cl. H01M 8/00; H01M 8/028; H01M 8/0286

(52) U.S. Cl. CPC H01M 8/002; H01M 8/028; H01M 8/0286; H01M 2250/20

(57) ABSTRACT

Embodiments are directed to a method for fabricating a fuel cell. According to one embodiment, the fuel cell fabricating method includes the steps of laying up multiple strips of fabric over a mold to form an enclosure for the storage of fuel, and bonding the strips to one another using a bonding agent. When the bonding agent has cured, the mold may be removed from the enclosure.

### BACKGROUND

Auxiliary fuel cells may be used to extend the range of a helicopter or other type of aircraft. Depending upon the size and type of the aircraft, auxiliary fuel cells may be disposed outside the aircraft, or internally under seats, in cargo bays, and the like. For some applications, such as when used in surveillance, an added fuel cell may essentially be a permanent installation. For other operations, such as in rescue operations, it is often desirable that an auxiliary fuel cell be easily installed or removed in order to re-configure the aircraft as quickly as possible. The auxiliary fuel cells used on certain aircraft can be quite large, thus rendering an overall weight factor that is not trivial. For example, some helicopter designs using fuel cells that carry up to one-hundred gallons is not uncommon. Such fuel cells can weigh over 200 pounds, a weight that can affect the overall performance of the helicopter.

Auxiliary fuel cells for aircraft are designed to provide extra fuel capacity on an as needed basis. These cells are frequently placed into and out of service, based upon the mission in which the aircraft is being used. Because they are frequently handled, their sidewalls are often rigid in structure. Conventionally, these fuel cells are manually produced in two independent steps. First, The internal flexible bladder is fabricated using techniques to ensure it meets crash-worthy and ballistic tolerances. Secondly, a rigid hard shell is fabricated around the internal flexible bladder followed by inserting the flexible bag into the rigid shell and attaching them together at the port and fitting locations.

### SUMMARY

Embodiments are directed to a method for fabricating a fuel cell. According to one embodiment, the fuel cell fabricating method includes the steps of laying up multiple strips of fabric over a mold to form an enclosure for the storage of fuel, and bonding the strips to one another using a bonding agent. When the bonding agent has cured, the mold may be removed from the enclosure.

According to another embodiment, a fuel cell fabricating method includes the steps of obtaining a desired dimensional size and shape for a fuel cell, creating a mold according to the desired dimensional size and shape for the fuel cell, fabricating the fuel cell over the mold, and when fabrication of the fuel cell is complete, removing the mold from the fuel cell.

According to yet another embodiment, an aircraft fabricating method includes the steps of fabricating a fuel cell for the aircraft by: laying up a plurality of strips of fabric over a mold to form an enclosure for the storage of fuel, bonding the strips to one another using a bonding agent, and removing the mold from the enclosure when the bonding agent has cured.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example aircraft that can be used with certain embodiments of the disclosure.

FIG. 2 illustrates an example fuel cell that may be configured on the aircraft of FIG. 1 according to one embodiment of the present disclosure.

FIG. 3 illustrates an exploded, enlarged, partial view of one of the side walls of the fuel cell according to one embodiment of the present disclosure.

FIGS. 4A and 4B illustrate an example mold that may be used to fabricate the fuel cell according to one embodiment of the present disclosure.

FIG. 5 illustrates one embodiment of how the crash-worthy and ballistically tolerant material may be laid up on the mold according to one embodiment of the present disclosure.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

Conventionally, crash-worthy and ballistically tolerant flexible fuel cells are largely produced via labor intensive processes. These processes typically involve placing and adhering large pieces of elastomeric coated textiles and/or pre-elastomeric coated textiles onto a mold. Areas where the textile pieces overlap require additional adhesives, tailoring, and curing processes, which often results in heavier, more rigid cells. Furthermore, with manual processes, the human element is prone to defects, scrap generation, cell-to-cell variation, and longer lead times. As will be described in detail herein below, embodiments of the present disclosure provide a crash-worthy and ballistically tolerant fuel cell and method of making the same that leverages additive manufacturing techniques using high-performance materials such that, in some cases, can be manufactured robotically.

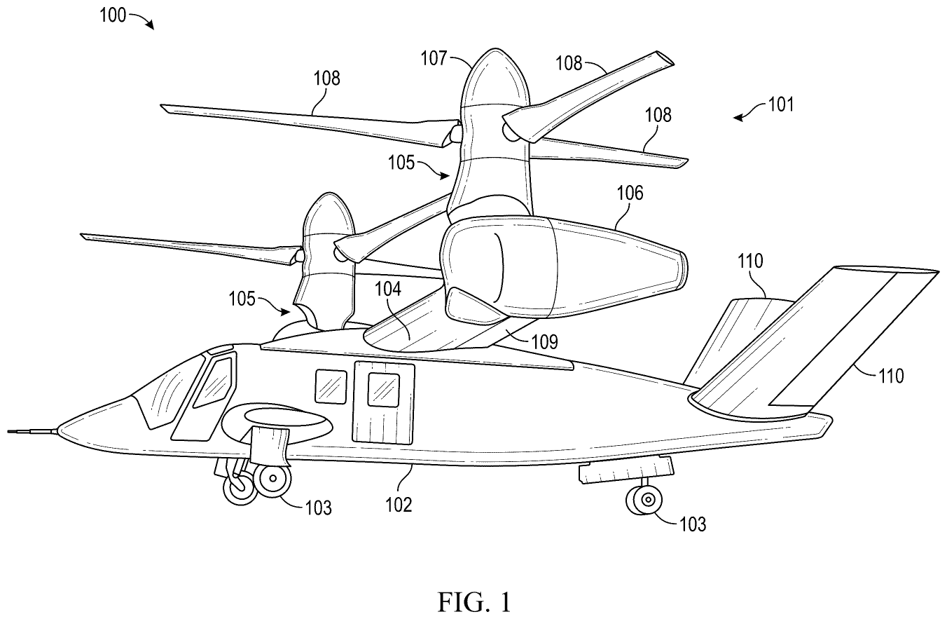

FIG. 1. illustrates an aircraft 101. Certain embodiments of the disclosure may be used with an aircraft, such as aircraft 101. However, aircraft 101 is used merely for illustration purposes. It will be understood that composite materials manufactured using the embodiments disclosed herein may be used with any aircraft, including fixed wing, rotorcraft, commercial, military, or civilian aircraft, or any other non-aircraft structure requiring a hollow or tubular construction. Embodiments of the present disclosure are not limited to any particular setting or application, and embodiments can be used with a rotor system in any setting or application such as with other aircraft, vehicles, or equipment. Certain embodiments of the composite assemblies and methods of forming such disclosed herein may be used for any application involving a composite, aerodynamically shaped object. For example, some embodiments of the composite assemblies disclosed herein may be used for the rotors, propellers, wings, or control surfaces of an aircraft.

Aircraft 101 may include fuselage 102, landing gear 103, and wings 104. A propulsion system 105 is positioned on the ends of wings 104. Each propulsion system 105 includes an engine 106 and a proprotor 107 with a plurality of rotor blades 108. Engine 106 rotates proprotor 107 and blades 108. Proprotor 107 may include a control system for selectively controlling the pitch of each blade 108 to control the direction, thrust, and lift of aircraft 101. Although FIG. 1 shows aircraft 101 in a helicopter mode wherein proprotors 107 are positioned substantially vertical to provide a lifting thrust. It will be understood that in other embodiments, aircraft 101 may operate in an airplane mode wherein proprotors 107 are positioned substantially horizontal to provide a forward thrust. Proprotors 107 may also move between the vertical and horizontal positions during flight as aircraft 101 transitions between a helicopter mode and an airplane mode. Wings 104 may provide lift to aircraft 101 in certain flight modes (e.g., during forward flight) in addition to supporting propulsion systems 105. Control surfaces 109 on wing 104 and/or control surfaces 110 are used to adjust the attitude of aircraft 101 around the pitch, roll, and yaw axes while in airplane mode. Control surfaces 109 and 110 may be, for example, ailerons, flaps, slats, spoilers, elevators, or rudders. Wings 104, rotor blades 108, and/or control surfaces 109, 110 may be composite assemblies each comprising a spar and a set of upper and lower skins that extend along the spar. In some embodiments, the composite assemblies may have an upper core, a lower core, and a septum support layer extending between the upper and lower cores.

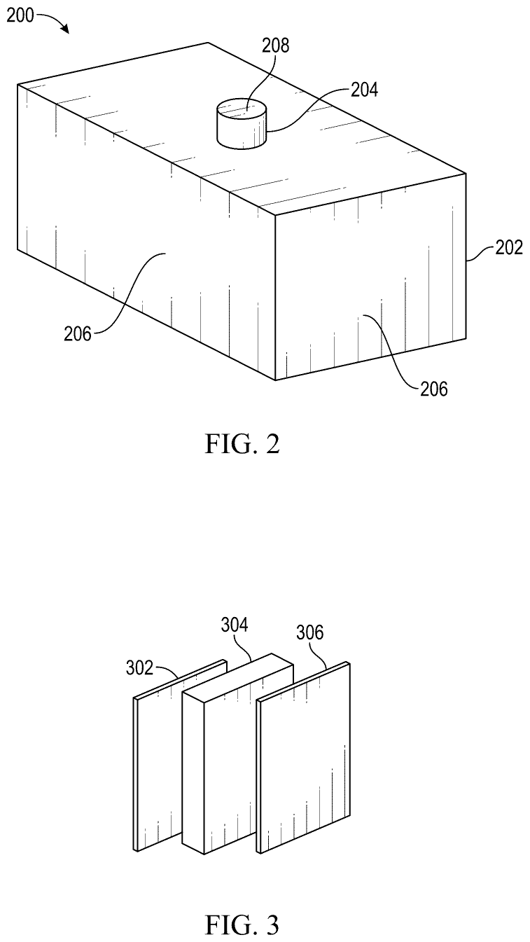

Referring now to FIG. 2, a fuel cell 200 is shown that may be configured on the aircraft 101 of FIG. 1 according to one embodiment of the present disclosure. While the fuel cell 200 is described herein as being configured for placement in an aircraft 101 embodied as a helicopter (e.g., rotorcraft), it should be appreciated that the fuel cell 200 can be configured in any suitable type of vehicle, such as a rotorcraft, fixed wing aircraft, an automobile, a tank, and the like, for which crash-worthiness and/or ballistic tolerance is desired. These fuel cells may be made to be intentionally rigid or flexible. For example, a flexible fuel cell may have less than or equal to eighty-five Shore A durometer, while a rigid fuel cell may have greater than or equal to sixty Shore D durometer in hardness.

The fuel cell 200 includes an enclosure 202 coupled to a fill port 204 from which fuel may be introduced into or removed from the enclosure 202. The fuel cell 200 may also include an access port (not shown) for coupling to an engine on the aircraft 101. As shown, the enclosure 202 has walls 206 that form a rectangular cuboid shape, however in other embodiments, the enclosure 202 may have any desired shape. For example, in cases where the fuel cell 200 is configured for placement within the aircraft 101, the fuel cell 200 may be configured to have a size and shape that conforms to and fits within an available space inside of the aircraft 101. As another example, in cases where the fuel cell 200 is configured for placement external to the aircraft 101, the fuel cell 200 may be configured to have a size and shape that that is aerodynamic for reduced air resistance. In one embodiment, the fill port 204 may be configured with a flange or other structural feature for receiving and holding a cap (not shown) on its opening 208.

FIG. 3 illustrates an exploded, enlarged, partial view of one of the side walls 206 of the fuel cell 200 according to one embodiment of the present disclosure.

The side walls 206 include an inner fuel barrier layer 302, a crash-worthy and ballistically tolerant layer 304, and an outer exterior shell layer 306. The fuel barrier layer 302 may be formed of any material that is chemically resistant and essentially inert to the type of fuel that the fuel cell 200 is configured to contain. In one embodiment, the fuel barrier layer 302 may be made of polyvinylidene fluoride or polyvinylidene difluoride (PVDF), and has a thickness of approximately 0.0030 inches. In some embodiments, the fuel barrier may be imparted with electrostatic discharge (ESD) properties that mitigate the chances of triggering an ESD ignition. An elastomeric film may be coupled to the PVDF fuel barrier. This secondary fuel tolerant layer may serve as a fuel barrier safety net and helps with self-sealing during ballistic attacks. Layers are typically 10 to 100 mils in thickness, and may be made of polyurethane, polyurea, synthetic rubbers, and elastomers.

The crash-worthy and ballistically tolerant layer 304 is formed of multiple strips of crash-worthy and ballistically tolerant material that are additively laid up in order to provide the fuel cell 200 with its finished shape. In one embodiment, the strips may be made of a para-aramid material (e.g., KEVLAR), an ultra-high molecular weight polyurethylene (UHPWPE) material (e.g., DYNEEMA), or a combination of the two. UHPWPE material is beneficial in that it is lightweight and has relatively good tensile strength for resisting impact from foreign substances, such as bullet, shrapnel, or debris as would be encountered if the aircraft 101 is involved in a wreck, or enemy fire. Para-aramid material, on the other hand, possesses a relatively high glass transition temperature point and melting point such that fast moving impacts caused by projectiles such as bullets do not cause the crash-worthy and ballistically tolerant material to melt precipitously. In one embodiment, the relative amounts of each crash-worthy and ballistically tolerant material may be selected according to the intended use of the fuel cell 200. For example, a fuel cell 200 may be made with 70 percent (%) para-aramid material and 30% UHPWPE material to enhance the fuel cell's resistance to bullet impact, while another fuel cell 200 may be made with 40% para-aramid material and 60% UHPWPE material to optimize its crashworthiness to weight ratio(s). How the strips are laid up to form the fuel cell 200 will be described in detail herein below.

The exterior shell 306 may be configured to add rigidity and durability to the finished shape of the fuel cell 200. In one embodiment, the exterior shell 306 may be made of poly urea that is applied to or otherwise sprayed onto the crash-worthy and ballistically tolerant layer 304 and allowed to cure. The thickness, hardness, or structural qualities would be designed to meet the end use application needs. That is, the protective shell could be a consequence of the materials and their forms that are being manually or robotically laid-up to meet the survivability needs of the tank. For example, the tank could be post treated with localized heating to trigger the materials with low Tg to flow and upon cooling have created a protective film. That is to say that the leading edge of the robot arm would apply materials and adhesives, while the trailing edge provides the heat.

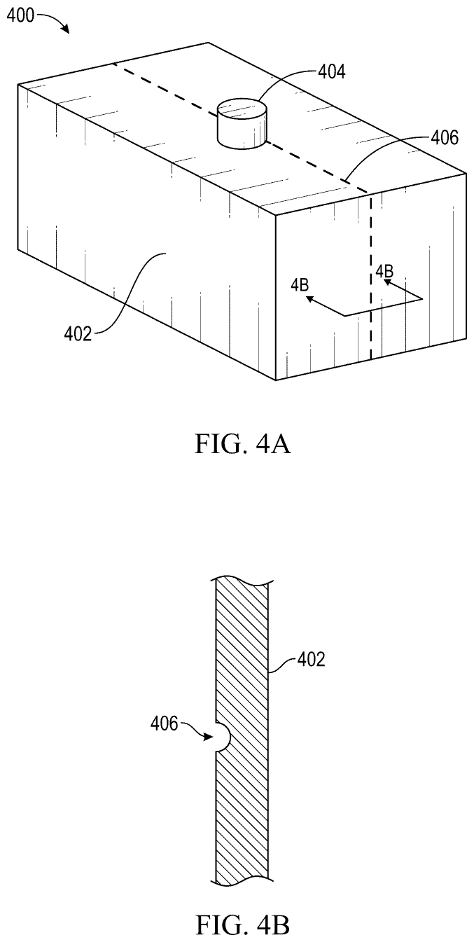

FIGS. 4A and 4B illustrate an example mold 400 that may be used to fabricate the fuel cell 200 according to one embodiment of the present disclosure. In general, the mold 400 has sidewalls 402 and a throat 404 with a shape that the inner enclosure 202 and fill port 204 of a fabricated fuel cell 200 is configured to have. The mold 400 is sufficiently rigid to hold its shape while the layers 302, 304, and 306 are applied to its outer surface, yet sufficiently flexible to allow it to be removed through the opening 208 and in some cases reused after the layers 302, 304, and 306 have finished curing.

In one embodiment, the mold 400 may be made using a three dimensional (3D) printing process. The 3D printing process may be beneficial in that multiple fuel cells 200 can be fabricated that have a consistent size and shape. The mold 400 may be configured for single use (e.g., use once then throw away), or configured for multiple uses. If configured for multiple uses, the mold 400 may be formed of a material having a sufficient resiliency to return to its original shape after having been removed from the enclosure 202 of the cured fuel cell 200. The mold 400 may also include an elongated depression 406 shown in phantom, which will be described in detail herein below with reference to FIG. 4B.

Referring now to FIG. 4B, a profile view of a portion of the sidewalls 402 taken along the lines 4B-4B of FIG. 4A is shown according to one embodiment of the present disclosure. As shown, the sidewall 402 is configured with an elongated depression 406 that extends from the throat 404 of the mold around the inner periphery to the opposing side of the throat 404. The elongated depression 406 forms a separable joint that can be torn apart to enhance ease of removal of the mold 400 from the enclosure 202 of the fuel cell 200 after being cured. In some embodiments, multiple elongated depressions 406 may be formed in the mold at different directions, particularly with larger tanks having smaller removal ports.

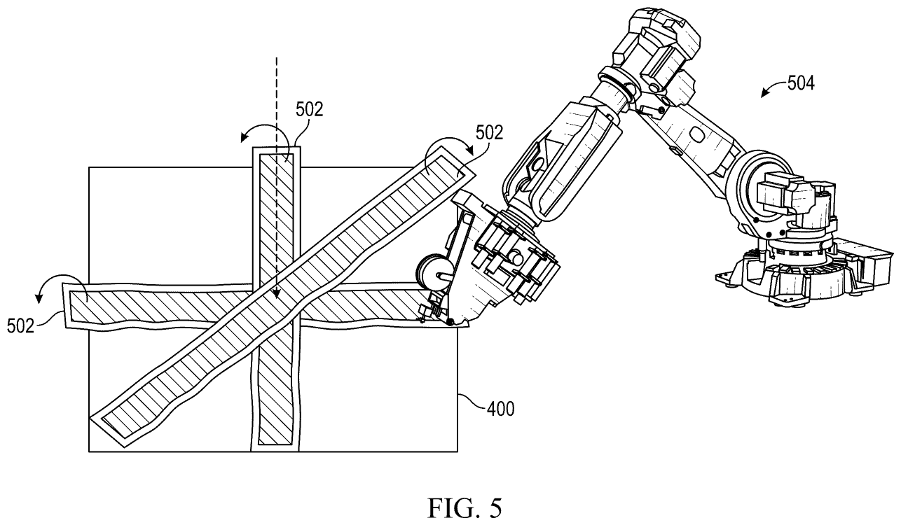

FIG. 5 illustrates one embodiment of how the crash-worthy and ballistically tolerant material may be laid up on the mold 400 according to one embodiment of the present disclosure. Initially, once the mold 400 has been fabricated or otherwise extracted from a previously fabricated fuel cell 200, the fuel barrier layer 302 may be applied to the outer surface of the mold 400, such as by robotically spraying or manually brushing. In some embodiments, a mold release agent may be applied to the mold 400 prior to applying the fuel barrier layer 302.

Once the fuel barrier layer 302 has cured, multiple strips 502 (approximately 4 inches in width) of crash-worthy and ballistically tolerant material may be laid up over the fuel barrier layer 302 to form the crash-worthy and ballistically tolerant layer 304. In one embodiment, the successive strips 502 may be laid up at oblique angles relative to the previously laid up strips 502. In some embodiments, the strips 502 may be narrower than 4 inches or wider than 4 inches. Laying up the strips 502 at oblique angles may be beneficial in that the tensile strength qualities of the crash-worthy and ballistically tolerant material can be optimized for the various stresses that may be encountered during use of the fuel cell 200.

Any number of layers of strips 502 may be applied. For example, the finished crash-worthy and ballistically tolerant layer 304 may be configured to have as few as one layer or over thirty layers of strips 502. In one embodiment, the number of strip layers may be selected according to a desired level of rigidity, flexibility, or level of crash-worthiness or ballistic tolerance of the finished fuel cell 200. For example, if the fuel cell 200 is adapted for placement inside of the aircraft 101, relatively fewer layers may be used such that the finished fuel cell 200 possesses sufficient flexibility for ease of insertion or extraction from tight or confined spaces within the aircraft 101. If, on the other hand, the fuel cell 200 is adapted for placement external to the aircraft 101 (as in the case of auxiliary fuel tanks), a relatively greater number of layers may be used such that the finished fuel cell 200 possesses sufficient rigidity for withstanding forces that may be encountered in an external environment.

After each or several layers of strips 502 have been laid up on the mold 400, a bonding agent may be used to secure the strips 502 to the previously laid up strips 502. Any suitable type of bonding agent material may be used such as is commonly known in the art. In one embodiment, the strips 502 may be laid up on the mold 400 using a robot 504. Use of a robot 504 may be beneficial in that it may be programmed to lay up the strips 502 in a more consistent pattern than what could otherwise be accomplished manually. In some embodiments, robot 504, may be equipped with ancillary equipment, to where the bonding agent and the strips 502, can be co-applied. The bonding agent may also be optimized for rigidity or flexibility. Resin systems are well known in the trade for making rigid, carbon fiber based composites. This novel application lay-up flexible composite textiles (para-aramid and/or UHMWPE), and bonding layers/strips together using bonding agents that are flexible. For example, 2-part urea systems or water based or solvent based acrylics or other suitable: liquid, hot-melt or powder based chemistries.

Once the strips 502 have been laid up on the mold 400, the outer exterior shell layer 306 may be applied over the strips 502. The thickness of the outer exterior shell layer 306 may be selected based upon the desired rigidity and durability of the fuel cell 200. The outer exterior shell layer 306 may be made of any suitable material, such as poly urea. In some embodiments, application of the outer exterior shell layer 306 may not be used.

After the outer exterior shell layer 306 has cured, the mold 400 may be extracted from the enclosure 202 of the fuel cell 200 through its fill port 204. In one embodiment, the mold 400 may be torn apart along one or more depressions 406 formed on the walls 402 of the mold 400. In another embodiment, the mold 400 may be removed from the finished fuel cell 200 without tearing the mold 400 so that it may be used again to make another fuel cell 200.

As described, certain embodiments of the present disclosure may solve several customer pain points that are associated with legacy survivable fuel cells. For example, conventional fuel cells are typically rigid, difficult to install, experience high failure rates, and have wide tank-to-tank dimensional tolerances. These long-standing pain points are a byproduct of a labor-intensive tank building process. Certain embodiments of the present disclosure may leverage the additive manufacturing techniques and high-performance materials, such that fuel cells can now be manufactured using robotic means. More specifically, the crash-worthy and ballistically tolerant materials (e.g., textile components) can be precisely and repeatedly positioned onto the molds for achieving more consistent tolerances. Further, the orientation and placement of these crash-worthy and ballistically tolerant materials can be engineered so that isotropic properties may be optimized. This can translate to fewer layers needed to robustly meet a user's exacting survivability needs. In some embodiments, layers 302 and 306 can be robotically applied (e.g., sprayed). Current process often uses robotics for the precision application of these functional layers. The ability to hold tighter tolerances would translate to tanks that have higher capacity, which may be of high value to certain customers.

Additionally, certain embodiments may reduce the high variation and costs associated with legacy hand layup processes. The fabrication process converts crash-worthy and ballistically tolerant materials into strips (approximately 4 inches in width), which are then robotically placed onto an inner fuel barrier layer 302. These lightweight flexible strips of high performance crash-worthy and ballistically tolerant strips 502 are simultaneously adhered via attachment methods that maintain the final fuel cell flexibility. Once the strips 502 are applied, a final protective outer exterior shell layer 306 may be robotically spray applied. The oblique placement of strips 502 in different directions can increase the isotropic crash-worthy and ballistic tolerance properties of the fabricated fuel cell 200. In some embodiments, survivability forces are not uniform across the surface area of a tank. Therefore with precision placement, only those areas of higher vulnerability would require additional reinforcement, which could translate to a lower overall weight.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

1. A fuel cell fabricating method comprising:
laying up a plurality of strips of fabric over a mold to form an enclosure for the storage of a liquid;
bonding the strips to one another using a bonding agent; and
removing the mold from the enclosure when the bonding agent has cured.

2. The fuel cell fabricating method of claim 1, further comprising, prior to laying up the strips of fabric over the mole, applying a fuel barrier layer over the mold.

3. The fuel cell fabricating method of claim 1, further comprising, after the strips of fabric have been laid up over the mold, applying an exterior shell layer over the mold.

4. The fuel cell fabricating method of claim 1, further comprising creating the mold using a three-dimensional (3D) printing process.

5. The fuel cell fabricating method of claim 4, further comprising forming a separable joint in the mold.

6. The fuel cell fabricating method of claim 4, further comprising reusing the mold to fabricate another fuel cell.

7. The fuel cell fabricating method of claim 1, further comprising laying up the strips using a robot.

8. The fuel cell fabricating method of claim 1, further comprising laying up the strips of fabric at oblique angles relative to one another over the mold.

9. The fuel cell fabricating method of claim 1, wherein the strips of fabric comprise a crash-worthy and ballistically tolerant material.

10. A fuel cell fabricating method comprising:
obtaining a desired dimensional size and shape for a fuel cell;
creating a mold according to the desired dimensional size and shape for the fuel cell;
fabricating the fuel cell over the mold; and
when fabrication of the fuel cell is complete, removing the mold from the fuel cell.

11. The fuel cell fabricating method of claim 10, wherein the fuel cell is fabricated by:
laying up a plurality of strips of fabric over a mold to form an enclosure for the storage of fuel;
bonding the strips to one another using a bonding agent; and
removing the mold from the enclosure when the bonding agent has cured.

12. The fuel cell fabricating method of claim 10, wherein the desired dimensional shape and size comprises an aerodynamic shape, and wherein the fuel cell is configured to be mounted externally on a vehicle.

13. The fuel cell fabricating method of claim 10, wherein the desired dimensional shape and size comprises an available space inside of a vehicle.

14. The fuel cell fabricating method of claim 13, wherein the vehicle comprises an aircraft.

15. An aircraft fabricating method comprising:
fabricating a fuel cell for the aircraft by:
laying up a plurality of strips of fabric over a mold to form an enclosure for the storage of fuel;
bonding the strips to one another using a bonding agent; and
removing the mold from the enclosure when the bonding agent has cured.

16. The aircraft fabricating method of claim 15, further comprising, prior to laying up the strips of fabric over the mold, applying a fuel barrier layer over the mold.

17. The aircraft fabricating method of claim 15, further comprising, after the strips of fabric have been laid up over the mold, applying an exterior shell layer over the mold.

18. The aircraft fabricating method of claim 15, further comprising creating the mold using a three-dimensional (3D) printing process.

19. The aircraft fabricating method of claim 15, further comprising laying up the strips using a robot.

20. The aircraft fabricating method of claim 15, further comprising laying up the strips of fabric at oblique angles relative to one another over the mold.
